(19) United States
(12) Patent Application Publication
(10) Pub. No.: US 2024/0233167 A9
(43) Pub. Date: Jul. 11, 2024

(54) INFORMATION PROCESSING DEVICE, INFORMATION PROCESSING METHOD, AND STORAGE MEDIUM

(71) Applicant: CANON KABUSHIKI KAISHA, Tokyo (JP)

(72) Inventors: Akira GOTODA, Tokyo (JP); Eiji TAKEUCHI, Kanagawa (JP)

(21) Appl. No.: 18/489,985

(22) Filed: Oct. 19, 2023

(30) Foreign Application Priority Data
Oct. 21, 2022 (JP) 2022-169259

(51) Int. Cl. G06T 7/70; G06T 7/20; G06V 10/25; G06V 20/56

(52) U.S. Cl. CPC G06T 7/70; G06T 7/20; G06V 10/25; G06V 20/588; G06T 2207/10024; G06T 2207/30256

(57) ABSTRACT

In order to reduce the influence of a detected position error caused by a position estimation error factor on a road surface, an information processing device acquires an image, detects an object position in the image based on the image, transforms the object position in the image into an object position in world coordinates, calculates a reliability of the object position in the world coordinates, determines whether the object position is influenced by a position estimation error factor on a road surface, changes the reliability of the object position according to a result of the error factor presence determination, and estimates a speed of an object by using a past history of the object position in the world coordinates and a past history of the reliability after the change.

### BACKGROUND OF THE INVENTION

### Field of the Invention

The present invention relates to an information processing device, an information processing method, a storage medium, and the like for detecting a position of an object.

### Description of the Related Art

Conventionally, there is a technology of detecting a position of an object (for example, a vehicle) in an image, transforming the detected position in the image into world coordinates, and estimating a speed by using a position information history of the object after transformation. There is a technology such as a Kalman filter as a representative method for estimating a speed of an object from a position information history and position reliability information of the object.

Japanese Patent Laid-Open No. 2019-191728 discloses a technique for changing observation noise that is the reliability of a detected position of an object, according to the type or a position/posture of the object in order to improve the accuracy of object speed estimation using the Kalman filter.

However, when there are road markings or the like around an object (for example, a vehicle), a detected position of the object in an image may be unstable, and the speed estimation accuracy may decrease.

Japanese Patent Laid-Open No. 2019-191728 discloses a technique for changing observation noise that is the reliability of a position, according to the type or a position/posture of an object. However, there is no disclosure of application processing according to the background such as road markings. Therefore, it is not possible to cope with a position estimation error factor on a road surface such as a road marking.

### SUMMARY OF THE INVENTION

According to one aspect of the present invention, there is provided an information processing device including
at least one processor or circuit configured to function as:
   an image acquisition unit configured to acquire an image;
   an object position detection unit configured to detect an object position in the image based on the image;
   a coordinate transformation unit configured to transform the object position in the image into an object position in world coordinates;
   a reliability calculation unit configured to calculate a reliability of the object position in the world coordinates;
   an error factor presence determination unit configured to determine whether the object position detected by the object position detection unit is influenced by a position estimation error factor on a road surface;
   a reliability changing unit configured to change the reliability of the object position according to a determination result from the error factor presence determination unit; and
   a speed estimation unit configured to estimate a speed of an object by using a past history of the object position in the world coordinates and a past history of the reliability after the change.

Further features of the present invention will become apparent from the following description of embodiments with reference to the attached drawings.

### BRIEF DESCRIPTION OF THE DRAWINGS

FIG. 1 is a bird's-eye view of a system related to Embodiment of the present invention.

FIG. 2 is a block diagram showing a configuration example of observation devices 100 and 101 and an integration device 110.

FIG. 3 is a functional block diagram showing functions performed by the CPU 201.

FIG. 4 is a flowchart showing an example of processing performed by the CPU 201.

FIGS. 5A and 5B are diagrams for describing coordinate transformation in Embodiment.

FIG. 6 is a flowchart for describing processing performed by a CPU 221.

FIG. 7 is a functional block diagram for describing the detailed configuration of a mobile object tracking (prediction) unit 34.

FIG. 8 is a flowchart for describing detailed processing in step S430 in FIG. 4.

FIGS. 9A to 9F are diagrams for describing an example in which an error occurs in a detected position of an observation target vehicle due to the influence of road markings.

FIGS. 10A to 10I are graphs for describing the effect of the present invention on the influence of a detected position error of the observation target vehicle due to road markings.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

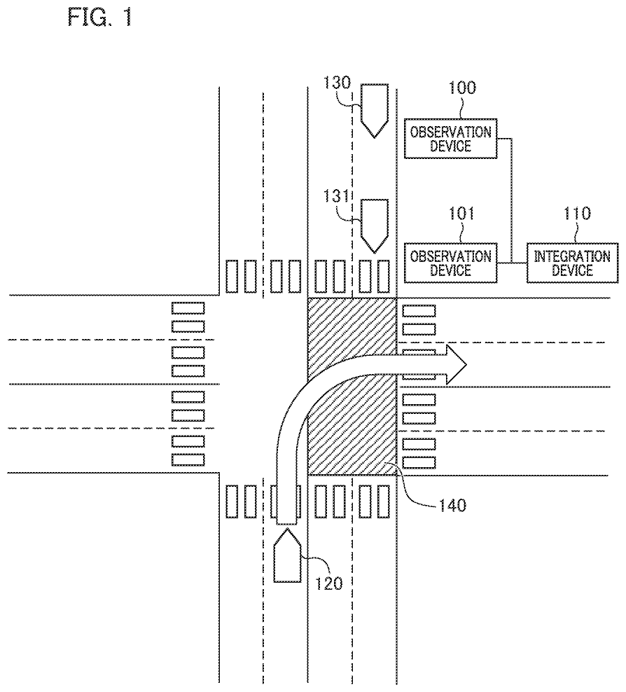

FIG. 1 is a bird's-eye view of a driving support system according to Embodiment of the present invention. Observation devices 100 and 101 are disposed near an intersection, and can communicate with an integration device 110. The observation devices 100 and 101 observe movements of observation target vehicles 130 and 131 and transmit data to the integration device 110.

When a notification target vehicle 120 turns right, the integration device 110 predicts the time at which the observation target vehicles 130 and 131 will reach the intersection, and notifies the notification target vehicle 120 of notification information such as whether or not the right turn is allowed. If the notification target vehicle 120 is, for example, an automated driving vehicle, acceleration, deceleration, stop, or the like can be determined based on the notification information.

It is preferable that the notification target vehicle 120 stops before a collision caution region 140 if notification information that the right turn is not allowed has been received. Even if the notification target vehicle 120 is not an automated vehicle, the driver of the notification target vehicle 120 can use the notification information to determine whether to accelerate, decelerate, stop the vehicle, or the like. Incidentally, the observation devices 100 and 101 function as mobile object tracking devices that are information processing devices in Present Embodiment.

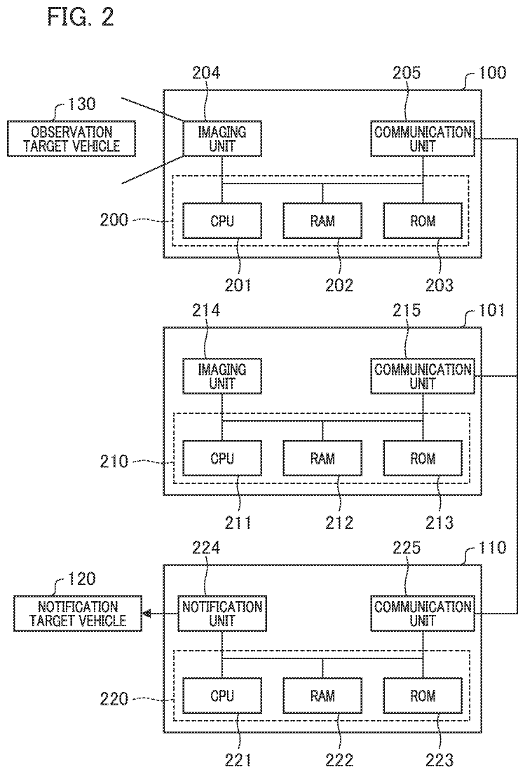

FIG. 2 is a block diagram showing a configuration example of the observation devices 100 and 101 and the integration device 110. Since the observation device 100 and the observation device 101 have the same configuration, only the observation device 100 will be described. The observation device 100 has a PC 200, an imaging unit 204, a communication unit 205, and the like.

The PC 200 includes a CPU 201 as a computer and a RAM 202 and a ROM 203 as memories, which can communicate with each other via a bus. The imaging unit 204 includes a network camera or the like. A mobile router or the like may be used for the communication unit 205. The PC 200, the imaging unit 204, and the communication unit 205 are connected to a LAN via a switching hub and can communicate with each other.

The integration device 110 includes a PC 220, a notification unit 224, and a communication unit 225. The PC 220 includes a CPU 221 as a computer and a RAM 222 and a ROM 223 as memories, which can communicate with each other via a bus.

The notification unit 224 may have a unit that can notify the notification target vehicle 120, and may also be used as the communication unit 225 as long as a notification can be performed by using wireless communication. Alternatively, the notification unit 224 may be a device such as a display or a speaker. A mobile router or the like may be used for the communication unit 225. The PC 220, the notification unit 224, and the communication unit 225 are connected to a LAN via a switching hub and can communicate with each other.

Note that the configuration shown in FIG. 2 is only one example, and the present invention is not limited to this. For example, any number of observation devices and imaging units may be used. A plurality of PCs, CPUs, RAMs, ROMs, and communication units may be common to each other or further divided. The communication unit may be of a wired or wireless type.

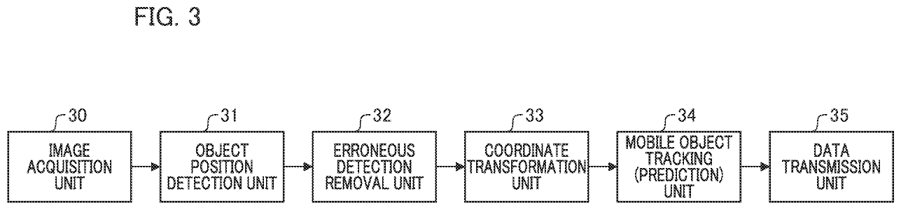

Next, FIG. 3 is a functional block diagram for describing the functions performed by the CPU 201. Note that the functions performed by the CPU 211 are the same, and thus description thereof will be omitted. Some of the functional blocks shown in FIG. 3 are realized by causing the CPU 201 as a computer included in the observation device 100 to execute a computer program stored in a memory as a storage medium.

However, some or all of the functions may be realized by hardware. As hardware, a dedicated circuit (ASIC), a processor (a reconfigurable processor or a DSP), or the like may be used.

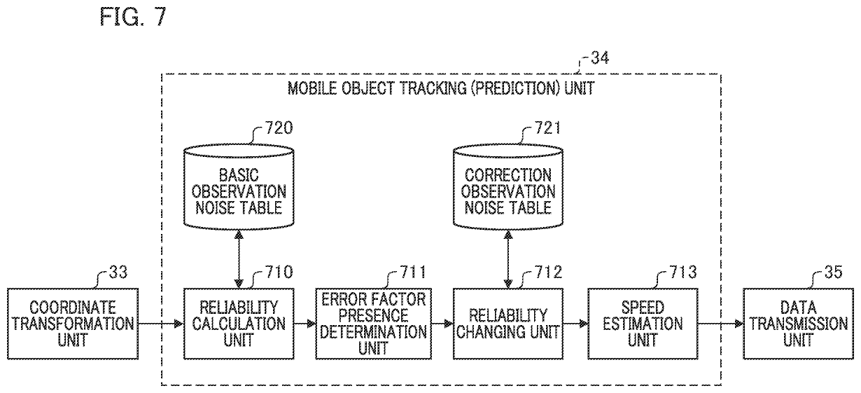

The respective functional blocks shown in FIG. 3 do not need to be built in the same housing, and may be configured by separate devices connected to each other via signal paths. Note that the above description of FIG. 3 also applies to FIG. 7.

The functional blocks shown in FIG. 3 include an image acquisition unit 30, an object position detection unit 31, an erroneous detection removal unit 32, a coordinate transformation unit 33, a mobile object tracking (prediction) unit 34, a data transmission unit 35, and the like. The image acquisition unit 30 executes an image acquisition step of acquiring a captured image from the imaging unit 204. The object position detection unit 31 performs image recognition based on the captured image and detects an object position in the image.

The erroneous detection removal unit 32 removes erroneous detection in the object position detection unit 31. The coordinate transformation unit 33 transforms the object position in the image (image coordinates) to an object position in world coordinates. The mobile object tracking (prediction) unit 34 estimates a speed, an advancing direction, and the like of an object. The data transmission unit 35 transmits an estimation result to the integration device 110.

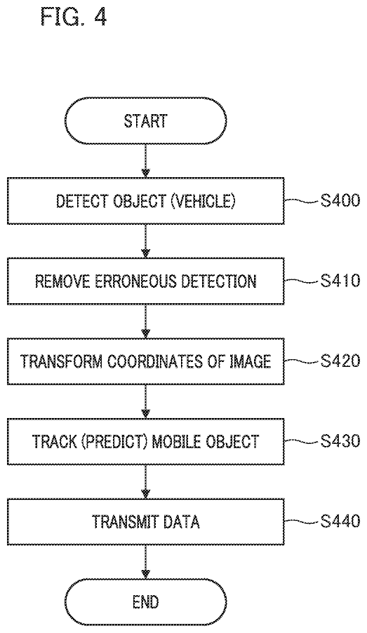

Next, FIG. 4 is a flowchart showing an example of processing performed by the CPU 201. The CPU 201 as a computer executes the computer program stored in the memory to perform an operation of each step in the flowchart of FIG. 4. Note that the processing performed by the CPU 211 is the same, and thus a description thereof will be omitted.

A correspondence relationship between the functions in the block diagram of FIG. 3 and the processing in FIG. 4 is as follows. The object position detection unit 31 performs the process in step S400. The erroneous detection removal unit 32 performs the process in step S410. The coordinate transformation unit 33 performs the process in step S420. The mobile object tracking (prediction) unit 34 performs the process in step S430. The data transmission unit 35 performs the process in step S440.

The flow in FIG. 4 is started when a captured image is acquired from the imaging unit 204. The imaging unit 204 periodically acquires captured images at, for example, 60 frames/second, and the flowchart of FIG. 4 is performed for each frame. The CPU 201 reads the computer program stored in advance in the ROM 203, loads the computer program to the RAM 202, and performs processing.

In step S400 (object position detection step), the CPU 201 detects an object such as a vehicle from the captured image acquired from the imaging unit 204 through image recognition. That is, in step S400, an object position in the image is detected based on the image. A model trained through deep learning may be used for the unit that detects an object. Abounding box is attached to the detected object.

In step S410, the CPU 201 removes erroneous detection from the object detected in step S400. In order to accurately detect objects such as vehicles and motorcycles that are detection targets, detection of unintended objects is curbed by changing an identifier in advance or adjusting a threshold value of an identification result.

On the other hand, if a process of adding a bounding box to a detected object in a captured image is performed, there may be a plurality of bounding boxes and there may be a region where the bounding boxes overlap each other.

In that case, processing may be performed such that all objects are located at a position of a bounding box that can be determined to be the closest to the imaging unit. Consequently, for example, if a person is riding a motorcycle, it can be determined that the motorcycle and the person are present at the position of the motorcycle, and thus it is possible to improve the determination accuracy of whether or not right turn is allowed to be reported to the notification target vehicle 120.

In step S420 (coordinate transformation step), the CPU 201 coordinate-transforms (projection transformation) the position of the object in the captured image from camera coordinates (plane) to world coordinates (plane). That is, in step S420, the object position in the image is transformed into an object position in the world coordinates.

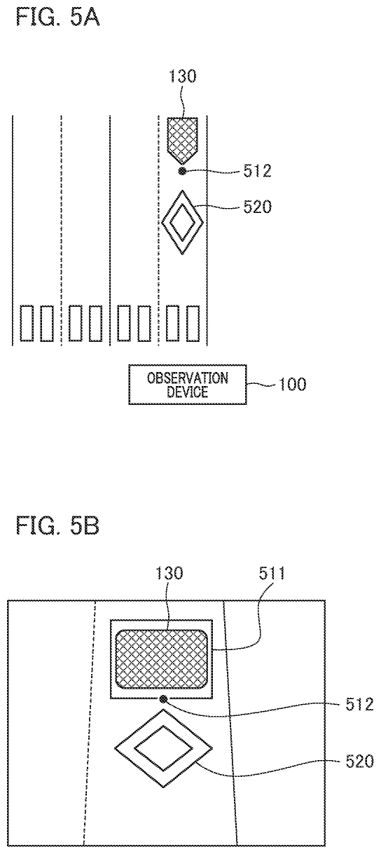

FIGS. 5A and 5B are diagrams for describing coordinate transformation in First Embodiment. FIG. 5B shows a captured image, and a position on the captured image may be transformed into camera coordinates (plane). FIG. 5A corresponds to world coordinates (plane). The world coordinates (plane) are the same as a road surface (plane) (it is assumed that world coordinates and the road surface are not globally the same, but are locally the same).

Note that a projection transformation matrix for coordinate transformation may be generated from a position of an observation device or a three-dimensional information of an imaging target. A 3D scanner or the like may be used to acquire three-dimensional information. Alternatively, as another method, corresponding points of an orthoimage including map information such as latitude and longitude and an image captured by the imaging device of the observation device 100 may be associated with each other such that a protective transformation matrix used for coordinate transformation may be created.

For example, feature points of a road marking 520 in FIG. 5A and feature points of a road marking 520 in FIG. 5B may be associated. By storing the projection transformation matrix in the ROM 203 in advance, the CPU 201 may use the projection transformation matrix for coordinate transformation. the CPU 201 can obtain depth information from the imaging device through the coordinate transformation.

A bounding box 511 in FIG. 5B is obtained by detecting the observation target vehicle 130 in step S400. A position of the observation target vehicle 130 may be represented by a position 512 that is the middle point of the lower side of the bounding box 511.

The coordinate transformation in step S420 is performed, and thus the position of the observation target vehicle 130 in the world coordinates (plane) can be represented by one point at the position 512 in FIG. 5A. The above method of determining the position of the observation target vehicle 130 is only an example, and the present invention is not limited to this method.

In step S430, the CPU 201 performs mobile object tracking (prediction) of a position of the observation target vehicle 130. The imaging unit 204 acquires captured images periodically, and by tracking a position of the observation target vehicle 510 in a plurality of frames, it is possible to predict a future position.

In step S440, the CPU 201 transmits information such as the predicted position of the observation target vehicle 130 to the CPU 221 of the PC 220 of the integration device 110 via the communication units 205 and 225.

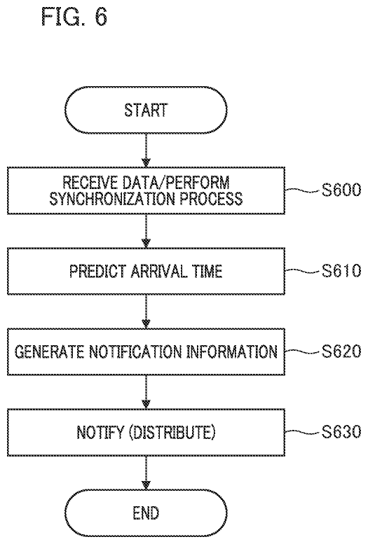

Next, FIG. 6 is a flowchart for describing processing performed by the CPU 221. The CPU 221 as a computer executes the computer program stored in the memory to perform an operation of each step in the flowchart of FIG. 6. The CPU 221 reads the computer program stored in advance in the ROM 223, loads the computer program to the RAM 222, and performs processing.

In step S600, the CPU 221 receives information such as the predicted position of the observation target vehicle from each of the observation devices 100 and 101. The number of observation target vehicles is not limited to one, and may be plural. The CPU 221 performs a synchronization process based on time information at which each of the observation devices 100 and 101 acquires an image.

In step S610, the CPU 221 predicts a time until the observation target vehicle reaches the collision caution region 140 at the intersection or an arrival time. If there are a plurality of observation target vehicles, the earliest arrival time at the collision caution region 140 is predicted.

If there are a plurality of lanes, a leading vehicle in each lane is predicted. The CPU 221 may determine the likelihood of a collision between the observation target vehicle and the notification target vehicle 120 based on characteristics of the notification target vehicle 120, and may determine whether the notification target vehicle 120 is allowed to turn right and perform a notification thereof.

The characteristics of the notification target vehicle 120 include, for example, at least one of an acceleration force, mass, a size, and a vehicle type (a large vehicle, a medium/small vehicle, a motorcycle, or the like) of the notification target vehicle 120. The CPU 221 may also determine whether the notification target vehicle 120 is allowed to turn right according to environmental conditions such as road structures (inclinations, curves, or the like) and weather conditions.

In step S620, the CPU 221 generates notification information to be reported to the notification target vehicle 120, such as whether or not right turn is allowed. Information other than whether or not right turn is allowed may include information such as an arrival time of the observation target vehicle 130 and the vehicle type. In step S630, the CPU 221 notifies the notification target vehicle 120 of the notification information. The notification may be provided through wireless communication via the communication unit 225.

FIG. 7 is a functional block diagram for describing the detailed configuration of the mobile object tracking (prediction) unit 34. The mobile object tracking (prediction) unit 34 includes a reliability calculation unit 710, an error factor presence determination unit 711, a reliability changing unit 712, a speed estimation unit 713, a basic observation noise table 720, a correction observation noise table 721, and the like. Observation noise expresses the uncertainty of an observation value and is expressed by a covariance matrix of errors.

The reliability calculation unit 710 executes a reliability calculation step for calculating the reliability of an object position in the world coordinates. The reliability here is observation noise regardless of a position estimation error factor on the road surface. In Present Embodiment, the observation noise calculated here will be referred to as basic observation noise. Note that typical examples of position estimation error factors include road markings (a crosswalk, a stop line, a speed limit marking, and the like).

The error factor presence determination unit 711 determines whether the object position detected by the object position detection unit is influenced by a position estimation error factor (such as a road marking) on the road surface. The reliability changing unit 712 changes the reliability of the object position (basic observation noise) according to the determination result from the error factor presence determination unit 711.

Note that in Present Embodiment, a correction amount for observation noise calculated by the reliability changing unit 712 will be referred to as correction observation noise, and the observation noise after correction calculated here will be referred to as applied observation noise.

The correction observation noise table 721 stores a table for calculating correction observation noise. The speed estimation unit 713 estimates a speed of the object by using the past history of the object position in the world coordinates and the past history of the reliability after the change.

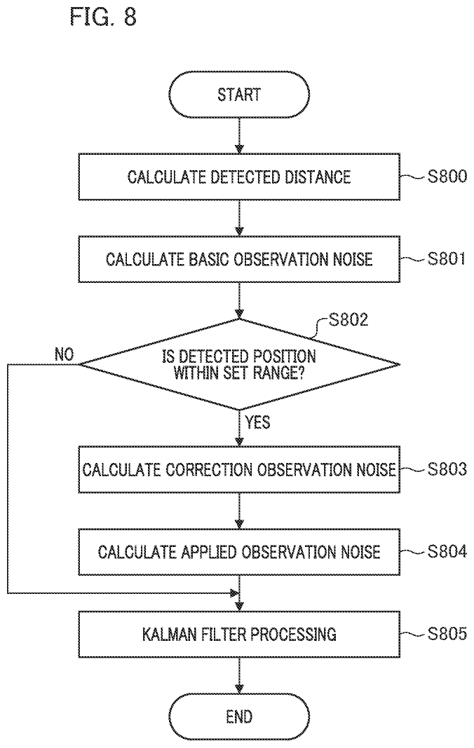

FIG. 8 is a flowchart for describing detailed processing in step S430 in FIG. 4. The CPU 201 as a computer executes the computer program stored in the memory to perform an operation of each step in the flowchart of FIG. 8. According to the processing flow of the mobile object tracking (prediction) unit in FIG. 8, an actual position and speed of the observation target vehicle are estimated from the history information of the detected position of the observation target vehicle including errors.

A correspondence relationship between the functional blocks in FIG. 7 and the processing in FIG. 8 is as follows. The reliability calculation unit 710 performs the processes in steps S800 and S801. The error factor presence determination unit 711 performs the process in step S801. The reliability changing unit 712 performs the processes in steps S803 and S804. The speed estimation unit 713 performs the process in step S805.

First, in step S800, a Euclidean distance between a position of the imaging unit 204 in the world coordinates and a detected position of the observation target vehicle 130 is calculated. In Present Embodiment, the Euclidean distance calculated here will be referred to as a detected distance.

The position of the imaging unit 204 in the world coordinates is set in advance. The detected position of the observation target vehicle 130 in the world coordinates employees the position calculated in step S420. A difference between these two positions is taken to calculate a detected distance as a Euclidean distance.

In the next step S801 (reliability calculation step), the basic observation noise, which is observation noise if there is no position estimation error factor (a road marking or the like) on the road surface, is calculated as the reliability. That is, in step S801, the reliability of the object position in the world coordinates is calculated.

The basic observation noise is changed according to the detected distance calculated in step S800. An observation noise table for a detected distance is prepared and stored in advance, and basic observation noise is calculated from the detected distance calculated in step S800 and the observation noise table.

The observation noise table in this case may be changed according to the recognition type. The observation noise table may be changed according to an installation height or an installation angle of the imaging unit. Alternatively, the observation noise table may be set to a fixed value regardless of a detected distance.

The observation noise table is created from statistical data of the detected position of the observation target vehicle if there is no position estimation error factor (a road marking or the like) on a road measured in advance and correct position data of the observation target vehicle separately prepared. The correct data may be generated by installing and surveying an observation target vehicle.

Sensors such as a global positioning system (GPS), a light detection and ranging (LiDAR), and an imaging unit may be installed separately and used to obtain correct data.

As a statistical processing method, a variance is calculated for the difference between the detected position of the observation target vehicle and the correct data. In this case, a variance may be calculated for a difference between average values of detected positions of the observation target vehicle without using the correct data. The observation noise table may be calculated by performing statistical processing for each recognition type, for each installation height of the imaging unit, and for each installation angle of the imaging unit.

The observation noise table may be calculated from statistical data of detected positions of the observation target vehicle in the camera coordinates. In this case, table data may be created by transforming variance values in the camera coordinates into variance values in the world coordinates by using coordinate transformation.

In the next step S802, it is determined whether or not the detected position of the observation target vehicle 130 is within a preset determination region range. In the Present Embodiment, a region for determining whether or not there is the influence of a position estimation error factor (a road marking or the like) on the road surface will be referred to as a determination region, and step S802 also functions as a determination region decision unit that determines a determination region.

Step S802 also functions as an error factor presence determination step for determining whether or not the object position detected in step S400 as an object position detection step is influenced by a position estimation error factor on the road surface.

In Present Embodiment, the determination region can be set by a user using a setting value. The determination region may be set according to the type of road marking or the size of the road marking in the camera coordinates. The determination region may be designated as a region in the camera coordinates, or may be designated as a region in the world coordinates.

An example of a method of determining a setting value of the determination region will be described below. Statistical data of detected positions of the observation target vehicle if there are road markings and separately prepared correct position data of the observation target vehicle are collected in advance. If a difference between the detected position of the observation target vehicle on the camera coordinates and the correct position is equal to or more than a threshold value, data in this case is regarded as erroneous detection data influenced by a position estimation error factor on the road surface.

In this case, the detected position of the observation target vehicle in the erroneous detection data is somewhere near the road marking. A road marking coordinate system is set based on a specific location of the road marking, and the detected position of the observation target vehicle in the camera coordinates is transformed into the road marking coordinate system. Statistical data of erroneous detection data of the observation target vehicle in the road marking coordinate system in this case is acquired.

The region including an erroneously detected position occurring in this statistical data is set as the determination region. As a criterion for the included region, a region including 90% of erroneously detected positions may be used. When this statistical data is acquired, statistics may be obtained for each road marking type, each road marking size in the camera coordinates, each inclination of a road marking, and each size in the camera coordinates of an observation target vehicle.

By collecting this statistical data before the imaging unit to be used is installed, it is possible to select an appropriate determination region based on the above statistical data when the determination region is set. However, if there is no appropriate statistical data, a determination region may be set by collecting statistical data after the imaging unit to be used is installed.

As a determination region determination method in the determination region decision unit, there may be a configuration in which a determination region may be automatically set by using the road marking detection unit. In that case, a road marking is learned in advance through deep learning or the like so that the type and a position of the road marking can be recognized. Statistical data of erroneous detection data is obtained for each type of road marking recognized in advance, and each size and each posture in the camera coordinates.

A table for setting a determination region for the types of road markings recognized from this statistical data and sizes or postures of the road markings in the camera coordinates is created. After the imaging unit is installed, the road marking detection unit recognizes a road marking, and the determination region decision unit automatically sets a determination region based on a road marking type as a result of the recognition, and a size and a posture in the camera coordinate. That is, the determination region is calculated in advance according to a detection result from the road marking detection unit.

The determination of whether or not there is the influence of a position estimation error factor (a road marking or the like) on the road surface may be performed by using an amount of change in a bounding box size. That is, the object position detection unit 31 may generate the bounding box, and the error factor presence determination unit 711 may determine whether an object position is influenced by the position estimation error factor on the road surface based on the amount of change in the size of the bounding box. In that case, the determination may be performed by referring to a history of bounding box information.

If information to be used is an aspect ratio of the bounding box, if an amount of change in the aspect ratio is equal to or more than a threshold value, it is determined that there is the influence of the position estimation error factor on the road surface. The determination may be performed based on a change in at least one of an aspect ratio, a vertical size, a horizontal size, and a lower end position of the bounding box.

Whether or not there is the influence of the position estimation error factor on the road surface may be determined by using an amount of change in a white region ratio within the bounding box. Examples thereof will be described below. A white region is calculated by binarizing the inside of the bounding box with a signal level.

Next, a ratio of the white region calculated through the binarization to the number of pixels in the bounding box is used to calculate a white region ratio. If an amount of change in the white region ratio is equal to or more than a threshold value, it is determined that there is the influence of the position estimation error factor on the road surface.

Note that the determination may be performed by using, for example, a change in a ratio of a yellow region instead of the white region ratio. That is, it may be determined whether or not an object position is influenced by the position estimation error factor on the road surface based on an amount of change in a predetermined color region within a bounding box in an image.

In the next step S803, correction observation noise for reducing the influence of the position estimation error factor on the road surface is calculated. This process is performed if it is determined that there is the influence of the position estimation error factor on the road surface.

Here, the correction observation noise table stored in advance is used to calculate the correction observation noise according to the detected distance. This correction observation noise table may be changed according to the recognition type. The table data may be changed according to an installation height or an installation angle of the imaging unit. The table data may be changed according to a size of the road marking in the camera coordinates. A fixed value may be used regardless of a detected distance.

The correction observation noise table is created from statistical data of detected positions of the observation target vehicle and correct data if there is a road marking measured in advance. If a difference between the detected position of the observation target vehicle on the camera coordinates and the correct position is equal to or more than a threshold value, data in this case is regarded as erroneous detection data influenced by a position estimation error factor on the road surface. Statistical processing is performed by using the erroneous detection data and the correct data.

As a statistical processing method, a variance is calculated for the difference between the erroneously detected position of the observation target vehicle in the world coordinates and the correct data. In this case, without using the correct data, a variance may be calculated for a difference between average values of erroneously detected positions of the observation target vehicle in the world coordinates.

In the correction observation noise table, statistical data may be calculated for each type of road marking, each size of the road marking in the camera coordinates, each recognition type of object, each installation height of the imaging unit, and each installation angle of the imaging unit. The correct data may be generated by installing and surveying the observation target vehicle. Sensors such as a GPS, a LiDAR, and a camera may be installed separately and used to obtain correct data.

The table may be calculated based on the statistical data of vehicle detected positions in the camera coordinates. In this case, table data may be created by transforming variance values in the camera coordinates into variance values in the world coordinates by using coordinate transformation. The correction observation noise table may store a difference value between values calculated in the basic observation noise table.

In the next step S804, the correction observation noise calculated in step S803 is used to correct the basic observation noise to calculate applied observation noise. A correction process is performed by overwriting correction observation noise with basic observation noise. There may be a configuration in which the basic observation noise and the correction observation noise are added together.

Thus, steps S803 and S804 function as reliability change steps for changing the reliability (observation noise) of the object position according to the determination result in the error factor presence determination step.

Next, in step S805, a speed of the object is estimated by using the past history of position information in the world coordinates and the past history of reliability of position information through Kalman filter processing. Here, step S805 functions as a speed estimation step of estimating a speed of the object by using the past history of the object position in the world coordinates and the past history of the reliability after the change.

Inputs in the Kalman filter processing are the detected position of the observation target vehicle in the world coordinates, the applied observation noise, and the detection time. This Kalman filter processing unit may employ the conventional technology without any change.

The Kalman filter may be divided into a prediction unit and an observation update unit. The Kalman filter internally stores state estimation values. The state estimation values are a three-dimensional position and a three-dimensional speed of the object in the world coordinates.

An error covariance matrix that is the reliability of the state estimation values is also stored. The error covariance matrix that is the reliability of the state estimation value will be referred to as estimation value noise. As inputs to the Kalman filter, the detected position of the observation target vehicle in the world coordinates, the observation time, and the applied observation noise, which are observation values, are input.

The mobile object tracking (prediction) unit uses the stored past speed and position (state estimation values) to predict a speed and a position at the observation time. In this case, the estimation value noise is also updated. The observation update unit updates the state estimation value and the state noise by using the detected position of the observation target vehicle in the world coordinates and the applied observation noise.

The Kalman filter outputs state estimation values of this observation update unit (for example, a three-dimensional position and a three-dimensional speed of the observation target vehicle). Incidentally, if the applied observation noise is larger than the estimation value noise, an output of the state estimation value of the observation update unit is weighted by the state estimation value of the prediction unit. There may be a configuration in which, in the Kalman filter processing, positions and speeds of a plurality of observation target vehicles are estimated. There may be a configuration in which a plurality of positions for detecting an object can be detected.

As an example of such a case, a multi-tracker Kalman filter will be described. Here, a combination of a state estimation value and state noise will be referred to as a tracker, and a configuration in which a plurality of trackers are stored and processing is performed will be referred to as a multi-tracker. In the multi-tracker Kalman filter, a plurality of combinations of state estimation values and state noise of the Kalman filter are stored.

In the multi-tracker Kalman filter, there are a plurality of detected positions of observation target vehicles and a plurality of trackers. Therefore, it is necessary to determine a correspondence relationship indicating which tracker corresponds to a detected observation target vehicle. In this case, it is determined that the detected position of the observation target vehicle and the state estimation value (position) of the tracker are close to each other as a correspondence relationship.

As correspondence determination, a position in the world coordinates may be returned to the coordinate system on the image, and a state in which an overlap rate of the bounding box is high may be regarded as a correspondence. After determining the correspondence, Kalman filter processing is performed between the correspondences. The processing in this case is the same as processing using the Kalman filter in a single tracker.

In the examples so far, an example in which a road marking as a position estimation error factor on the road surface is included. However, a position estimation error factor on the road surface in Present Embodiment is not limited to a road marking. For example, the position estimation error factor on the road surface may be a structure on the road surface such as a manhole, or may temporarily exist on the road surface such as snow, puddles, fallen objects (fallen leaves).

In the above embodiments, only a vehicle has been described as an observation target vehicle. However, an object in Present Embodiment is not limited to a vehicle. As long as an object is a mobile object, the object may be a person or an animal.

In the above embodiments, only the example of using a Kalman filter as the speed estimation unit 713 for estimating a speed of an object by performing filter processing by using the past history of position information in the world coordinates and the past history of reliability of position information has been described. However, the speed estimation unit 713 in Present Embodiment is not limited to the Kalman filter.

As the speed estimation unit 713, a Bayesian filter (such as a particle filter) other than the Kalman filter may be used, or an infinite impulse response filter (IIR filter) or a finite impulse response filter (FIR filter) may be used.

In the case of the IIR filter, a feedback gain may be changed instead of changing observation noise. In the case of the FIR filter, a weight may be changed instead of changing observation noise.

The configuration has been described so far in which the statistical data obtained in advance such as the basic observation noise table 720 and the correction observation noise table 721 is stored as tables and used. However, a form of storing statistical data in Present Embodiment is not limited to a table. Statistical data may be modeled and expressed as a functional expression.

By performing the above processing, it is possible to curb the deterioration in speed estimation accuracy due to detected position errors caused by a position estimation error factor on a road surface such as a road marking.

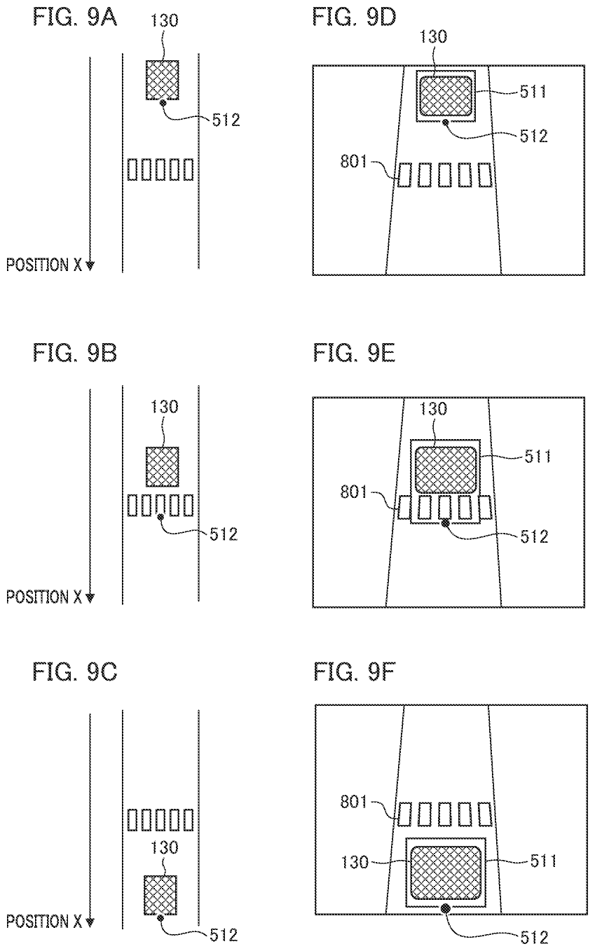

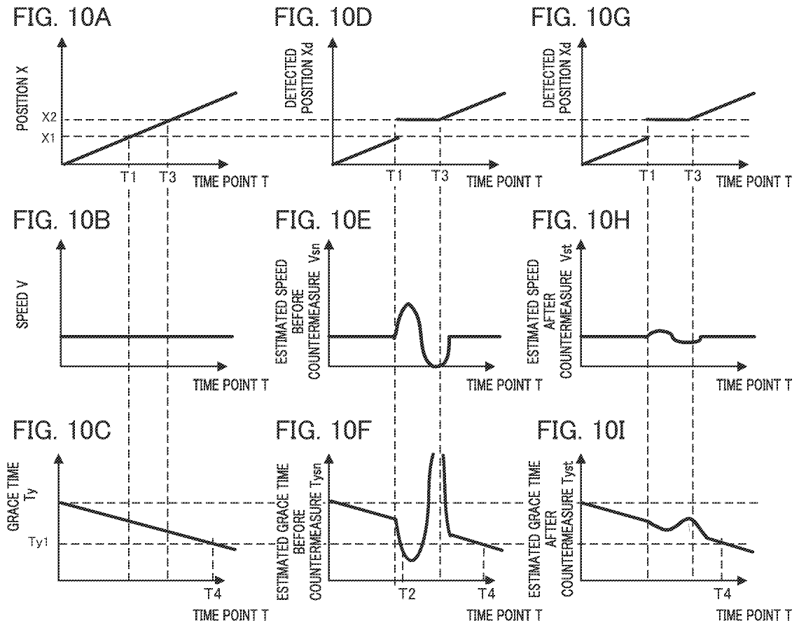

Next, an effect example of Present Embodiment will be described with reference to FIGS. 9A to 10I. First, FIGS. 9A to 9F are diagrams for describing an example in which an error occurs in a detected position of an observation target vehicle due to the influence of a road marking.

FIGS. 9A, 9B, and 9C express a behavior of the observation target vehicle in the world coordinates, and FIGS. 9A, 9B, and 9C show positions of the observation target vehicle at respective time points. The observation target vehicle 130 is moving in a positive direction of a position X. FIGS. 9D, 9E, and 9F express a behavior of the observation target vehicle in the camera coordinates.

FIG. 9D shows a behavior of the observation target vehicle at the same time as in FIG. 9A, FIG. 9E shows a behavior of the observation target vehicle at the same time as in FIG. 9B, and FIG. 9F shows a behavior of the observation target vehicle at the same time as in FIG. 9C. A bounding box 511 in FIGS. 9D, 9E, and 9F is a detection result of the observation target vehicle, and a position 512 is a position of the observation target vehicle in the camera coordinates. In FIG. 9D, the position 512 of the observation target vehicle is near the lower surface of the observation target vehicle 130.

On the other hand, if there is a road marking around the observation target vehicle, the bounding box 511 including the road marking (crosswalk 801) and the observation target vehicle may be detected as shown in FIG. 9E. In this case, the detected position 512 in the camera coordinates largely deviates from the lower surface of the observation target vehicle.

If the observation target vehicle in the camera coordinates is coordinate-transformed, the detected position 512 of the observation target vehicle in the world coordinates different from the actual position of the object is calculated as shown in FIG. 9B. As described above, a detected position of the observation target vehicle may deviate from a desired position due to the influence of a road marking.

Next, FIGS. 10A to 10I are graphs for describing the effect of Present Embodiment on the influence of a detected position error of the observation target vehicle due to a road marking. First, with reference to FIGS. 10A, 10B, and 10C, an actual position X, a speed V, an intersection entry grace time Ty of the observation target vehicle 130, and whether or not the notification target vehicle 120 is allowed to turn right will be described.

FIG. 10A is a graph in which a horizontal axis represents time and a vertical axis represents a correct position of the observation target vehicle 130 in the world coordinates. FIG. 10B is a graph in which a horizontal axis represents time and a vertical axis represents a correct speed of the observation target vehicle 130 in the world coordinates. The observation target vehicle moves at a constant speed as shown in FIG. 10B.

FIG. 10C is a graph in which the horizontal axis represents time and the vertical axis represents a grace time until the observation target vehicle enters the intersection. If the notification target vehicle 120 is possible to turn right within the grace period Ty1, the notification target vehicle 120 is allowed to turn right until time point T4, and is not allowed to turn right after time point T4.

Next, with reference to FIGS. 10D, 10E, and 10F, an example of a case where a detected position error caused by a position estimation error factor on a road surface such as a road marking is not considered will be described. FIG. 10D is a graph of in which the horizontal axis represents time and the vertical axis represents a detected position of the observation target vehicle in the world coordinates. In this example, a detected position error of the observation target vehicle occurs due to the influence of a road marking, and a detected position of the observation target vehicle in the world coordinates is substantially constant from time points T1 to T3.

FIG. 10E is a graph in which the horizontal axis represents time and the vertical axis represents an estimated speed of the observation target vehicle (before countermeasures: if a position estimation error factor on the road surface is not taken into account) in the world coordinates. From time points T1 to T3, the estimated speed changes greatly due to the influence of the road marking.

FIG. 10F is a graph in which the horizontal axis represents time and the vertical axis represents an estimated grace time, and is a graph if no countermeasures are taken against the position estimation error factor on the road surface. Due to great change in the estimated speed as shown in FIG. 10E, the estimated grace period also changes greatly.

As a result, in this example, the estimated grace time is shorter than the grace period Ty1 at time point T2, and it is determined that right turn is not allowed after time point T2. As a result, the notification target vehicle 120 is not allowed to turn right even at a timing at which the notification target vehicle 120 is actually possible to turn right. Next, with reference to FIGS. 10G, 10H, and 10I, an example of a case where a detection position error that occur due to a position estimation error factor on the road surface such as a road marking is considered as in Present Embodiment will be described. Similarly to FIG. 10D, FIG. 10G is a graph in which the horizontal axis represents time and the vertical axis represents a detected position of the observation target vehicle in the world coordinates. This detected position is the same as in FIG. 10D even in Present Embodiment.

FIG. 10H is a graph in which the horizontal axis represents time and the vertical axis represents an estimated position of the observation target vehicle 130 in the world coordinates in Present Embodiment. It can be seen that the influence of the road marking is reduced from time points T1 to T3 compared with that in FIG. 10E. This is because it is determined that there is the influence of the position estimation error factor during the time from time points T1 to T3, and as a result of increasing the observation noise, great speed estimation values before T1 are employed.

FIG. 10I is a graph in which the horizontal axis represents e time and the vertical axis represents an estimated grace time in Present Embodiment. Similarly to FIG. 10H, a change in the estimated speed is curbed compared with that in FIG. 10E. As a result, a change in the estimated grace time is also curbed similarly to that in FIG. 10I. Thus, in this example, it is determined that right turn is allowed until time point T4.

As described above, in Present Embodiment, it is possible to curb deterioration in speed estimation accuracy due to a detection position error caused by a position estimation error factor on a road surface such as a road marking. Consequently, it is possible to reduce an error in a grace time for an observation target vehicle to enter an intersection, and reduce cases where it is determined that the notification target vehicle 120 is not allowed to turn right even at a timing at which right turn is actually possible, and vice versa.

Present Embodiment can be realized by using the basic observation noise table 720 and the correction observation noise table 721. This table data is obtained in advance under various conditions, and the table is selected according to the situation after the imaging unit is installed. Therefore, it is desirable to prepare table data before installing the imaging unit.

By doing so, even if the reliability of a detected position of an observation target vehicle is not measured after the imaging unit is installed, deterioration in the speed estimation accuracy due to a detected position error caused by a position estimation error factor on a road surface such as a road marking can be curbed.

As described above, according to Present Embodiment, it is possible to provide a mobile object tracking device capable of curbing deterioration in the speed estimation accuracy due to a detected position error caused by a position estimation error factor on a road surface such as a road marking even if the reliability of a detected position of an observation target vehicle is not measured after the imaging unit is installed.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

As a part or the whole of the control according to the embodiments, a computer program realizing the function of the embodiments described above may be supplied to the information processing device and the like through a network or various storage media. Then, a computer (or a CPU, an MPU, or the like) of the information processing device and the like may be configured to read and execute the program. In such a case, the program and the storage medium storing the program configure the present invention.

The present invention includes a configuration realized by using, for example, at least one processor or circuit configured to function of the embodiments described above. Note that distributed processing may be performed by using a plurality of processors.

This application claims the benefit of Japanese Patent Application No. 2022-169259, filed on Oct. 21, 2022, which is hereby incorporated by reference herein in its entirety.

What is claimed is:

1. An information processing device comprising:
at least one processor or circuit configured to function as:
an image acquisition unit configured to acquire an image;
an object position detection unit configured to detect an object position in the image based on the image;
a coordinate transformation unit configured to transform the object position in the image into an object position in world coordinates;
a reliability calculation unit configured to calculate a reliability of the object position in the world coordinates;
an error factor presence determination unit configured to determine whether the object position detected by the object position detection unit is influenced by a position estimation error factor on a road surface;
a reliability changing unit configured to change the reliability of the object position according to a determination result from the error factor presence determination unit; and
a speed estimation unit configured to estimate a speed of an object by using a past history of the object position in the world coordinates and a past history of the reliability after the change.

2. The information processing device according to claim 1, wherein the position estimation error factor includes a road marking.

3. The information processing device according to claim 1, wherein the at least one processor or circuit is further configured to function as:
a determination region decision unit configured to decide in advance a determination region for determining whether or not there is an influence of the position estimation error factor on the road surface, and
the error factor presence determination unit performs the determination based on whether the object position detected by the object position detection unit is within a range of the determination region.

4. The information processing device according to claim 3, wherein the determination region is settable by a user using a setting value.

5. The information processing device according to claim 3, wherein the at least one processor or circuit is further configured to function as:
a road marking detection unit configured to detect a road marking from the image, and
the determination region is calculated in advance according to a detection result from the road marking detection unit.

6. The information processing device according to claim 1, wherein the object position detection unit generates a bounding box, and the error factor presence determination unit performs the determination based on an amount of change in a size of the bounding box.

7. The information processing device according to claim 1, wherein the object position detection unit generates a bounding box, and the error factor presence determination unit performs the determination based on an amount of change in a predetermined color region within the bounding box in the image.

8. An information processing method comprising:
acquiring an image;
detecting an object position in the image based on the image;
transforming the object position in the image into an object position in world coordinates;
calculating a reliability of the object position in the world coordinates;
determining whether the object position detected in the detecting the object position is influenced by a position estimation error factor on a road surface;
changing the reliability of the object position according to a determination result in the determining presence of an error factor; and
estimating a speed of an object by using a past history of the object position in the world coordinates and a past history of the reliability after the change.

9. Anon-transitory computer-readable storage medium configured to store a computer program comprising instructions for executing following processes:
acquiring an image;
detecting an object position in the image based on the image;
transforming the object position in the image into an object position in world coordinates;
calculating a reliability of the object position in the world coordinates;
determining whether the object position detected in the detecting the object position is influenced by a position estimation error factor on a road surface;
changing the reliability of the object position according to a determination result in the determining presence of an error factor; and
estimating a speed of an object by using a past history of the object position in the world coordinates and a past history of the reliability after the change.
